(19) United States
(12) Patent Application Publication
(10) Pub. No.: US 2026/0357779 A1
(43) Pub. Date: Nov. 12, 2026

(54) AN EFFECTOR FOR A WAVE POWER SYSTEM AND A WAVE POWER SYSTEM

(71) Applicant: WAVEPISTON A/S, Helsingør (DK)

(72) Inventors: Kristian GLEJBØL, Helsingør (DK); Martin VON BULOW, Helsingør (DK); Troels Vestergaard LUKASSEN, Helsingør (DK)

(73) Assignee: WAVEPISTON A/S, Helsingør (DK)

(21) Appl. No.: 19/129,761

(22) PCT Filed: Nov. 16, 2023
(86) PCT No.: PCT/DK2023/050279

§ 371 Date: May 14, 2025

(30) Foreign Application Priority Data
Nov. 16, 2022 (DK) PA 2022 70562

(51) Int. Cl. F03B 13/18; F03B 3/12; F03B 11/00

(52) U.S. Cl. CPC F03B 13/18; F03B 3/121; F03B 11/00; F05B 2260/90

(57) ABSTRACT

An effector for a wave power system and a wave power system are disclosed.

The effector comprises a beam structure and a plurality of paddles. Each paddle has a paddle shaft and at least one paddle blade with a first and a second opposite blade surfaces, a blade length along the paddle shaft and a blade width perpendicular to the blade length. The plurality of paddles are fixed to the beam structure, to provide that the paddle blades are located to form part of at least one common sail arrangement when said paddles are in unloaded condition. Each of the paddle blades, at least in a compliant blade section thereof is elastically deflectable upon a selected load applied to one of a first and a second opposite compliant blade section surfaces of the compliant blade section of the paddle blade.

### TECHNICAL FIELD

The invention relates to a wave power system for extracting energy from water waves, such as surface water waves e.g. in waters such as oceans, lakes or any other waters where water surface waves are generated by wind or other environmental influences.

### BACKGROUND ART

For many years, there has been high focus on environment friendly methods for generating energy, in particular extract of energy from sun, wind and water waves. Many different systems for extracting energy from water waves have been suggested. US 2007/0257491 discloses a wave power system comprising a plurality of generators comprising a float and a brake and a mechanical energy transmission system that harnesses wave energy and converts it into limited motion that is suitable for input to an electrical energy generator.

WO20257909 describes a wave energy harnessing system comprising a plurality of wave energy devices coupled together to form a high-capacity installation. The wave energy device includes a buoyant body, which maintains a permanent orientation relative to the surface of the ocean, while the power take-off (PTO) would self-align in the direction of the incoming waves. The power take-off is completely enclosed, above the waterline and easily accessible. The buoyant body is coupled to the buoyant bodies of other similar wave energy devices by flexible or articulating coupling means. The wave energy devices are arranged in arrays or any other suitable layouts, to form large connected floating structures.

US2020088155 discloses a wave power device for extracting energy from water waves. The wave power device comprise a reference structure and effectors moving relative to the reference structure. Each effector is connected to two hydraulic rams, symmetrically positioned around each effector. The hydraulic rams have an effective hydraulic area which is stepwise increased as the length of the hydraulic rams are compressed and stepwise decreased as the length of the hydraulic rams are increased.

A particular challenge for such wave power systems is that they are subjected to harsh environment in the water e.g. ocean water, both in respect of chemical and mechanical influences on the system. Violent storms are frequent, and aerated seawater is highly corrosive.

WO8100285 discloses a device for extracting energy from the motion of water beneath waves in a body of water, the apparatus comprising a sail structure comprises one or more sail sections each held in a rigid frame comprising horizontal and vertical frame sections, where the sail of each sail section is fixed between two vertical fame sections and wherein the orientation of the sails may be varied by turning the frames holding the sails to account for changes in the direction of the water movement.

DK201000570 describes a wave power device for extracting energy from water waves. The wave power device comprises a substantially stationary member and a plurality of resistance elements movably connected to and along the length of the substantially stationary member for example such that the resistance elements are movable with a maximal travelling distance due to force applied to the resistance element by water waves when the wave power device is in use. At least one of the resistance elements has a resistance element area and a resistance surface area, where the resistance surface area is defined as a projection of the resistance element area to a plane perpendicular to the length axis of the substantially stationary member. The resistance surface area is variable, for example automatically, semi automatically and/or manually adjustably e.g. in relation to the force applied.

### DISCLOSURE OF INVENTION

An objective of the present invention is to provide a wave power system, which is relatively robust and simultaneously effective for harvesting wave energy.

An objective of the present invention is to provide a wave power system, which is relatively robust and simultaneously effective for harvesting wave energy.

In an embodiment, it is an objective to provide an effector(s) for a wave power system, which effector has a relatively high effectivity and still having a desired high resistivity against being damaged even by violent waves.

In an embodiment, it is an objective to provide an effector and/or a wave power system, comprising such effector, wherein the effector may have a relatively high surface area for being moved effectively by the water waves wherein the effector at the same time is relatively robust and durable.

These and other objects have been solved by the inventions or embodiments thereof as defined in the claims and as described herein.

It has been found that the inventions or embodiments thereof have a number of additional advantages, which will be clear to the skilled person from the following description and claims.

It should be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other stated features.

The phrase “applying a load” and “applying a force” are used interchangeable. Thus, applying a force to the paddle blade surfaces results in applying a force to the paddle blade surfaces.

Reference made to “some embodiments” or “an embodiment” means that a particular feature(s), structure(s), or characteristic(s) described in connection with such embodiment(s) is included in at least one embodiment of the subject matter disclosed. Thus, the appearance of the phrases “in some embodiments” or “in an embodiment” in various places throughout the specification is not necessarily referring to the same embodiment(s). Further, the skilled person will understand that particular features, structures, or characteristics may be combined in any suitable manner within the scope of the invention as defined by the claims.

The term “substantially” should unless otherwise specified or clear from the context, be taken to mean that ordinary product variances and tolerances are comprised.

Throughout the description or claims, the singular encompasses the plural unless otherwise specified or required by the context.

All features of the invention and embodiments of the invention as described herein, including ranges and preferred ranges, may be combined in various ways within the scope of the invention, unless there are specific reasons not to combine such features.

The effector of the invention suitable for a wave power system comprises a beam structure and a plurality of paddles. Each paddle comprises a paddle shaft and at least one paddle blade. The paddle blade or the paddle blades is/are advantageously fixed to the paddle shaft. The paddle blade or the paddle blades may be fixed to the paddle shaft by being mounted to the paddle shaft e.g. mechanical or chemical. In an embodiment, the paddle blade or the paddle blades may be fixed to the paddle shaft by being integrated with the paddle shaft. The paddle blade has a first and a second opposite paddle blade surface, a blade width W along the paddle shaft and a blade length L perpendicular to the blade width W. The plurality of paddles are fixed to the beam structure e.g. via the respective paddle shafts, to provide that the paddle blades of the respective paddles are located to form part of at least one common sail arrangement when the paddles are in unloaded condition. Each of the paddle blades, at least in a compliant blade section thereof is elastically deflectable upon a selected load applied to one of the faces of the compliant blade section of the paddle blade.

When looking along the axis of the paddle, the paddle blade is fixed to the paddle shaft along a fixing length extending along at least a part of the paddle width, wherein the paddle advantageously has at least one free edge which is longer than the fixing length to allow the compliant blade section to deflect elastically. The paddle blades are not framed, but each paddle has at least one compliant blade section protruding away from the paddle shaft and with a free edge allowing the compliant blade section to deflect elastically in the direction of the applied load.

To ensure that the compliant blade section of the paddle blade is allowed to deflect elastically the paddle blade comprises a non-framed tip section comprising the compliant blade section.

The inventor of the present invention has found that by providing the effector to have a plurality of paddles, each comprising a paddle shaft and at least one paddle blade wherein the paddle blades are fixed to a beam structure e.g. via the respective paddle shafts, to provide that the paddle blades of the respective paddles are located to form part of at least one common sail arrangement and wherein each of the paddle blades, at least in a compliant blade section thereof is elastically deflectable upon a selected load applied to one of the faces of the compliant blade section of the paddle blade, a highly improved wave power system may be obtained.

Without being bound by the theory, it is believed that when the common sail is subjected to force by water waves acting of the one of the paddle blade surface of the paddle blades forming part of the at least one common sail arrangement, the common sail arrangement effectively collects energy by being moved by the waver waves having the paddle blades undeflected or only minor deflected as further described below. When the effector is moved with high speed caused by the waver waves towards an end stop, an amount of water is moving together with the effector and the common sail arrangement, and thereby adding a virtual mass to the common sail arrangement—this virtual mass is commonly called “added mass”. It is believed that the common sail arrangement thereby is surrounded by force applied by the virtual mass. It was found that attempt to provide prior art effectors to operate in different modes by changing orientation of the collecting faces of the effector, resulted in that the effector was subjected to damaging twisting forces which in addition made it difficult the control the switching between operation modes.

By providing each of the paddle blades of the paddles forming part of the common sail arrangement to have a compliant blade section, which compliant section is elastically deflectable upon a selected load applied to the face of the compliant blade section, this problem has now been alleviated. It is believed that the amount of water, which is moving together with the effector and the common sail arrangement when the effector is moved with high speed caused by the waver waves towards an end stop will be allowed to pass between the blades of the paddles due to the deflection of the respective compliant blade sections without damaging the blades. At the same time the selected load, and thereby the selected strength and flexibility of the blades, may be chosen such that it may be ensured that the respective compliant blade sections is only subjected to the elastically deflection or to any substantial elastically deflection as described further below upon a load that without the deflection may put the effector in risk of mechanical overload and failure or even in being fully damaged.

The effector of the invention is suitable for a wave power system, such as a wave power system described further below. The wave power system conveniently comprises a plurality of the effectors arranged to be moved by water waves to thereby harvesting energy which may be transformed e.g. via a generator or other means.

The effector comprises a beam structure and a plurality of paddles.

Each paddle comprises a paddle shaft and at least one paddle blade fixed to or integrated with the paddle shaft.

The paddle blade has a first and a second opposite paddle blade surfaces, a blade length along the paddle shaft and a blade width perpendicular to the blade length.

The plurality of paddles are fixed to the beam structure via the respective paddle shafts, to provide that the paddle blades are located to form part of at least one common sail arrangement when the paddles are in unloaded condition. A compliant blade section of each of the respective paddle blades comprises a first and a second opposite compliant blade section surfaces.

The compliant blade section is elastically deflectable upon a selected load applied to one of the first and the second compliant blade section surfaces of the compliant blade section of the paddle blade.

Preferably the paddle blades has a free edge opposite the respective paddle shafts. The first and the second opposite blade surfaces are provided by opposite facing surfaces of the paddle blade. The first and the second opposite blade surfaces are advantageously substantially flat when the paddle blade is in unloaded condition.

The term “unloaded condition” means herein when forces acting on the first and the second opposite blade surfaces are equal.

Each paddle blade may have equal or varying thickness over its extension (blade length and blade width) e.g. from the paddle shaft to furthest from the paddle shaft. In an embodiment, the paddle blade is thicker closer to the paddle shaft than further from the paddle shaft. In an embodiment, the paddle blade has a thickness which is gradually thinner from the paddle shaft to furthest from the paddle blade, the paddle blade may thereby have a gradually increasing compliance over its width from the paddle shaft to furthest from the paddle blade.

The blade length of the paddle blade is determined as the length of the paddle blade parallel to the paddle shaft. Where the length of the paddle blade is varying from the paddle shaft to furthest from the paddle shaft, the blade length is determined as the length of the paddle blade closest to the paddle shaft. In an embodiment, the paddle blade has a gradually decreasing length from the blade length adjacent the paddle shaft to furthest from the paddle shaft. In an embodiment, the paddle blade has a constant length in its entire width from the paddle shaft to furthest from the paddle shaft. Advantageously, the paddle blade has a free edge along its entire width from the paddle shaft to furthest from the paddle shaft.

The width of the paddle blade is determined from the paddle shaft to furthest from the paddle shaft and perpendicular to the blade length. Where the paddle blade has a varying width, the blade width is the largest width of the paddle blade.

The compliant blade section may be the entire paddle blade from the paddle shaft or it may be a section of the paddle blade. The compliant blade section preferably includes at least a tip section comprising a blade tip furthest from the paddle shaft. Advantageously, the first compliant blade section surface is the entire or a part of the first blade surface and the second compliant blade section surface is the entire or a part of the second blade surface.

Advantageously, the compliant blade section comprises 10% or more of the blade width from paddle shaft to a furthest edge, such as at 25% or more, such as 50% or more, such as 75% or more, such as 90% or more of the blade width preferably comprising the blade tip furthest from the from the paddle shaft in unloaded condition.

The compliant blade section may in an embodiment be the entire paddle blade. Advantageously, the compliant blade section comprises at least a portion of the paddle blade located furthest from the paddle shaft, such as at least a width portion of 25% of the blade width, such as at least a width portion of 50% of the blade width, as at least a width portion of 90% of the blade width.

The compliance of the compliant blade section may be equal in the entire compliant blade section or it may vary for example as a function of the distance to the paddle shaft. In an embodiment, the compliance is gradually increasing from closer to the paddle shaft to furthest from the paddle shaft. The variation in compliance may e.g. be provided by a variation in thickness of the paddle blade, i.e. the thinner the paddle blade the higher the compliance.

The compliant blade section may advantageously have a compliance, which is sufficiently high to provide that when a force in the interval of from 25 N to 1 kN is applied to one of the first and the second compliant blade section surfaces of each respective paddle blades, an edge of the paddle blade furthest from the paddle shaft will be angular displaced with at least 15° relative to the edge in unloaded condition without resulting in irreversible plastic deformation, preferably determined with the force is applied evenly over the compliant blade section or at a center location of the compliant blade section.

Conveniently, the compliant blade section has a compliance, which is sufficiently high to provide that when a force in the interval of from 25 N to 1 kN is applied to one of the first and the second compliant blade section surfaces of each respective paddle blades, an edge of the paddle blade furthest from the paddle shaft will be angular displaced with from 20° to 80°, such as from 25° to 60° relative to the edge in unloaded condition without resulting in irreversible plastic deformation, preferably determined with the force is applied evenly over the compliant blade section or at a center location of the compliant blade section.

The angular displacement of the edge of the paddle blade furthest from the paddle shaft is determined by the displacement of a tangent to the edge at a furthest location and perpendicular to the surface of the paddle blade on which the force is acting. The angular displacement may be determined by applying one or more moldable load elements, such as sand bags, with the selected load onto the compliant blade section and determine the angular displacement, e.g. as shown in the figures.

The desired compliance of a compliant blade section may be selected in dependence on the forces it is expected to be subjected to in use and therefor is designed for.

In an embodiment, the compliant blade section has a compliance sufficiently high to provide that when a force to one of the first and the second compliant blade section surfaces of each respective paddle blades, an edge of the paddle blade furthest from the paddle shaft will be angular displaced with at least 15°, relative to the edge in unloaded condition without resulting in irreversible plastic deformation, wherein the force is applied by water pressure by submerging the paddle blade fully in still standing standard seawater at 20 °C and moving the paddle blade horizontally in a first direction normal to the first surface of the paddle blade followed by a deceleration of 5 m/s².

In an embodiment, the compliant blade section has a compliance sufficiently high to provide that when a force to one of the first and the second compliant blade section surfaces of each respective paddle blades, an edge of the paddle blade furthest from the paddle shaft will be angular displaced with from 20° to 80°, such as from 25° to 60° relative to the edge in unloaded condition without resulting in irreversible plastic deformation, wherein the force is applied by water pressure by applying the paddle blade fully in still standing standard seawater at 20 °C and moving the paddle blade horizontally in a first direction normal to the first surface of the paddle blade followed by a deceleration of 5m/s².

The term “normal” means herein the vector, which initially before starting the motion is normal to the first surface of the paddle blade.

Testing can convenient be made as a test in a towing tank filled with water having a temperature of 20°) where a paddle is accelerated to a speed of 2 m/s and where the speed is maintained for at least 1 s, whereupon the paddle speed is decreased by 5 m/s² or more. During the test, the angular displacement of edge of the paddle blade furthest from the paddle shaft may conveniently be recorded using a camera.

Advantageously, the maximum angular displacement of the paddle relative to the first and/or the second compliant blade section surfaces immediately adjacent to the paddle shaft is or comprises the angular displacement of the tip of the paddle blade.

Generally it is desired that the compliant blade section is configured for deflecting or bending towards one direction at a time, i. e. the direction of the water flow. Thus, it is desired that the at least the tip of the blade section and preferably the entire compliant blade section is not constraint beyond the fixing to the paddle blade. Thus, from the paddle shaft and to the tip of the paddle blade the paddle blade is advantageously unconstraint.

Each of the at least one common sail arrangement comprises at least two paddles each with at least one paddle blade. The paddles of a common sail arrangement are located relative to each other, such that the blades of the paddles of the common sail arrangement, when in unloaded condition mimics a common sail optionally with narrow gaps between the respective paddle blades. Advantageously, the total gap area is less than 10% of a total area of the common sail arrangement.

In an embodiment, the paddle blades of a common sail arrangement are located in a side-by-side configuration, preferably such that any potential gaps between adjacent paddle blade when the paddles are in unloaded condition do not exceed 15% of the average blade width. Advantageously, the paddle blades of a common sail arrangement are located such that any potential gaps between adjacent paddle blades do not exceed 10% of the average blade width when the paddles are in unloaded condition, preferably such that the paddle blades of a common sail arrangement are located such that any potential gaps between adjacent paddle blades do not exceed 1% of the average blade width when the paddles are in unloaded condition.

In an embodiment, the paddle blades of a common sail arrangement are located in a side-by-side configuration, preferably such that any potential gaps between adjacent paddle blades when the paddles are in unloaded condition do not exceed 10 cm. Advantageously, the paddle blades of a common sail arrangement are located in a side-by-side configuration, preferably such that any potential gaps between adjacent paddle blades when the paddles are in unloaded condition do not exceed 5 cm, preferably the potential gaps is/are 2 cm or less when the paddles are in unloaded condition.

The paddle blade of the common sail arrangement may advantageously be arranged such that any potential gaps between the paddle blades when the paddles are in unloaded condition are as small as possible, while still allowing the compliant blade sections of the respective paddle blade to deflect when subjected to a selected load as described above. Thereby the risk of damaging the paddles due to the effect of added mass when the effector is decelerated or fully stopped after being moved e.g. accelerated a length through the water may be substantially decreased or fully avoided, while simultaneously ensuring an effective harvesting of energy from the water waves.

In an embodiment, the paddle blades of a common sail arrangement may overlap when the paddles are in unloaded condition. The overlap is advantageously relatively small to ensure that the compliant blade sections of the paddle blades are allowed to deflect when subjected to a selected load as described above, to thereby reduce the risk of damaging the paddles. The overlap has the function of ensuring an optimal harvestion of energy from the waves. An effective overlap between adjacent paddle blades may advantageously be at least 1 mm, such as at least 4 mm. To ensure that the overlap of the respective paddle blades allows the compliant blade sections to deflect elastically upon the selected load e.g. when subjected to the force of added mass and to ensure that the overlap of the respective paddle blades does not result in an undesired restriction of the compliant blade sections it is desired that the overlap is not exceeding 15% of the average blade width of the overlapping blades, such as not exceeding 10% of the average blade width of the overlapping blades,

In an embodiment, wherein the paddle blades of a common sail arrangement are located in a side-by-side configuration and wherein two or more of the paddle blades overlap with each other, the a maximal overlap of paddle blades advantageously is up to 15%, such as up to 10% of the average blade width of the overlapping blades. Preferably any potential overlaps between adjacent paddle blades do not exceed 5%, such as 1% of the average blade width of the overlapping blades when the paddles are in unloaded condition.

The at least one common sail arrangement may in principle include any number of paddle blades from two and above. In an embodiment, the at least one common sail arrangement comprises an even number of paddles. Thereby the common sail arrangement may be very stable and balanced, which may be beneficial for the motion of the effector by the water waves. Preferably the common sail arrangement comprises at least 4, such as from 4 to 40, such as from 18 to 40, such as from 16 to 24 paddles. Each of the paddles may comprise any number of paddle blades. The desired number of paddle blades on a paddle, highly depends on the size of the effector. Preferably the number of paddle blades of each paddle is 1 or an even number. When the number of paddle blades of a paddle is an even number, the paddle blade are advantageously located to protrude in opposite directions from the paddle shaft, preferable mirrored relative to the paddle shaft (i.e. the paddle shaft form a mirror axis). In an embodiment, each paddle of the common sail arrangement comprises up to 10 paddle blades.

The paddle blades may be symmetrical or non-symmetrical with respect to the respective paddle shafts.

In an embodiment, the one or more paddles comprises one single paddle blade fixed to or integrated with the paddle shaft. In an embodiment, the one or more paddles comprises two or more paddle blades fixed to or integrated with the paddle shaft along the length of the paddle shaft and protruding in the same direction from the paddle shaft. Such paddle blades are referred to as bordering paddle blades, whereas paddle blades protruding in opposite directions from the paddle shaft is referred to a opposite paddle blades.

In an embodiment, the one or more paddles comprises two or more opposite paddle blades, the opposite paddle blade may be symmetrical or non-symmetrical.

In an embodiment, each paddle comprises two or 4 opposite and symmetrical paddle blades.

Where the paddles comprises bordering paddle blades, the bordering paddle blades are advantageously located adjacent each other along the paddle shaft either overlapping, with no gab or with a minor gab between the paddle blades such as a minor gap of up to 1 m, such as up to 5 mm, such as up to 2 mm. In practice it may be difficult to arrange the bordering paddle blades with no gap between adjacent bordering paddle blades.

In an embodiment, the at least one common sail arrangement comprises at least one paddle comprising at least one rigid paddle blade. In practice it is desired that all the paddle blades of the common sail arrangement comprises a compliant blade section. The term “rigid” should herein be taken to mean that the rigid paddle blade is virtually inflexible, such as stiff during the ordinary and intended use of the effector.

For an effective operation paddle shafts conveniently are stiffer than the respective paddle blade attached thereto or integrated therewith. The higher stiffness may be provided by a higher thickness of the material or by an additional reinforcement of the material, e.g. where the paddle shafts and the paddle blades are of a composite material.

The paddle shaft advantageously has a higher flexural stiffness (determined by bending along the length of the paddle shaft) than the flexural stiffness of the compliant blade section (determined by bending along the width of the compliant blade section) of the at least one paddle blade of the respective paddles.

In an embodiment, the paddle shaft has a flexural stiffness which is at least 50%, such as at least 70%, such as at least 100% higher than the flexural stiffness of the compliant blade section of the respective paddle blades fixed to or integrated with the paddle shaft.

The beam structure may comprise at least one beam and preferably a plurality of interconnected beams. The interconnected beams may in principle have any configurations. Advantageously, the beams of the beam structure are located in a common plane. In an embodiment, the beam structure has a single beam. In an embodiment, the beam structure comprises two or more parallel beams. In an embodiment, the beam structure comprises at least two perpendicular beams.

Advantageously, the beam or the respective interconnected beams of the beam structure have independently of each other a higher flexural stiffness than the average flexural stiffness of the paddle shafts of the paddles of the effector. In an embodiment, the flexural stiffness of the respective interconnected beams of the beam structure are substantially identical to each other, i.e. within ±10% from the average flexural stiffness, such as within ±10% from the average flexural stiffness.

Preferably the respective interconnected beams has a flexural stiffness which is at least 50%, such as at least 70%, such as at least 100% higher than the average flexural stiffness of the compliant blade sections of the paddle blades of the paddles of the effector.

By providing the beam(s) or the beam structure with a relative high flexural stiffness it is ensured that the effector becomes very stable and effective in harvesting energy from the water waves.

The paddle shafts of the paddles comprising the paddle blades of the at least one common sail arrangement may be connected to at least one beam of the beam structure in respective rotational restricted joints. Such rotational restricted joints prevents the respective paddles from rotating about the respective beams they are connected to, which ensures an effective energy harvesting.

Preferably the respective rotational restricted joints are restricting the paddles from rotating about the respective paddle shafts more than 10°, such as more than 5°, such as fully restricting the paddles from rotating about the respective paddle shafts to which they are connected in the respective rotational restricted joints. In an embodiment, the respective paddle shafts are connected to the at least one beam in respective rigid connections.

In an embodiment, the paddle blades comprises at least one of a metal and/or a polymer material. It is desired that the compliant blade sections of the paddle blades are at least partly of a polymer material. For reinforcement the paddle blades may conveniently comprises metal, such as steel and/or aluminum.

In an embodiment, the paddle blades comprises a polymer such as polypropylene (PP), polyethylene (PE), polyoxymethylene (POM), polyurethane (PU), polyamide (PA), polyethylene terephthalate (PET), and/or thermoset epoxy.

The paddle blades may preferably comprise or consist of a composite material, such as fiber reinforced polymer, such as glass fiber reinforced polymer (GFRP), basalt fiber reinforced polymer (BFRP) and/or carbon fiber reinforced polymer (CFRP).

The phrase “composite material” means herein any structure comprising a thermoset polymer matrix and at least one embedded element, which is not of thermoset polymer.

The thermoset polymer is advantageously thermoset epoxy, which is highly chemical resistant and durable in sea water. Examples of embedded elements includes reinforcement elements, such as fibers and or metallic elements, polymer elements, filler elements, glue, fasteners etc. The composite structure may further comprise non- or partly embedded elements, such a coatings e.g. paint and/or UV/weather protective coating.

The term “embedded element” should herein be taken to mean that the embedded element is at least partly embedded in the matrix, preferably such that at least 50 volume % of the element is below a surface of the matrix. Advantageously, the embedded element is fully embedded in the matrix, i.e. the embedded element is surrounded by the matrix.

The one or more embedded elements may serve different purposes. Advantageously, the embedded solid elements comprises one or more reinforcements. The reinforcement elements, such as fibers are located and orientated in the paddle blade to ensure the desired compliance of the compliant blade section. In an embodiment, the concentration of fiber reinforcement in the paddle blade is higher closer to the paddle shaft than further from the paddle shaft.

The paddle shaft and/or the beam structure may comprise or consist of wood, metal and/or composite material. The wood may e.g. include balsa wood which is very buoyant. When using balsa or other types of wood it may conveniently be embedded in a thermoset polymer such as epoxy to thereby form part of the composite material, preferably together with reinforcement elements e.g. as described for the paddle blade above and preferably including metal, such as steel or aluminum and/or fibers e.g. as further described below.

In an embodiment, the paddle shaft(s) and/or at least one beam of the beam structure independent of each other is fully or partly of a metal and/or a polymer material, preferably the paddle shaft(s) and/or at least one beam of the beam structure independent of each other comprises steel, aluminum, polypropylene (PP), polyethylene (PE), polyoxymethylene (POM), polyurethane (PU), polyamide (PA), polyethylene terephthalate (PET), and/or a composite material, such as fiber reinforced polymer, such as glass fiber reinforced polymer (GFRP), basalt fiber reinforced polymer (BFRP) and/or carbon fiber reinforced polymer (CFRP).

Paddle shaft may conveniently be of or comprises metal, such a steel, e.g. polymer coated steel, composite material e.g. the composite material mentioned elsewhere herein.

In an embodiment, the paddle shaft and the paddle blade are of composite material. Preferably the paddle shaft has a higher concentration of reinforcement elements, such as reinforcement fibers that the compliant blade section.

In an embodiment, the composite material forming the paddle blade, the paddle shaft and/or a part or all of the beam structure may comprise one or more embedded elements that are not having reinforcing function, such as filler, shaping aid, electrical component, lightning protections, paint, glue and/or foams and/or woods e.g. for buoyance purposes.

Such foams may e.g. comprise foamed plastic such as foamed plastic comprising at least one of polystyrene (PS), polyurethane (PU), poly(vinyl chloride) (PVC), polyethylene terephthalate (PET), polyolefins (polyethylene (PE) and polypropylene (PP)) and ABS foams, preferably the foamed plastic is rigid. The foamed plastic is advantageously a closed cell foam.

The foamed plastic advantageously has a high fire resistance and ensure a light weight of the composite material.

The polymer of the composite material is in an embodiment, selected from natural rubber, polypropylene (PP), polyethylene (PE), polyoxymethylene (POM), polyurethane (PU), polyamide (PA), polyethylene terephthalate (PET), epoxy (e.g. modified epoxy e.g. PU modified epoxy).

The fibers of the composite material may comprise fibers selected from one or more of synthetic fiber, semi-synthetic fiber, regenerated fiber, plant fiber, carbon fiber, basalt fiber, glass fiber, animal fiber and/or metal fiber.

The fibers may advantageously form or form part of one or more reinforced elements. The synthetic fiber may comprise at least one of nylon, polyester, acrylic, polyvinyl chloride, polyurethane, vinylon, or aramid fiber. The semi-synthetic fiber may comprise at least one of acetate, triacetate, or promix fiber. The regenerated fiber may comprise at least one of rayon, cupro, or polynosic fiber. The plant fiber may comprise at least one of cotton or hemp fiber. The carbon fiber comprises at least one of pure carbon or pitch carbon. The animal fiber comprises at least one of hair, angora, spider silk, or mohair fiber. The metal fiber comprises at least one of silver or steel fiber.

In an embodiment the fibers comprises glass-, synthetic-, carbon-, plant-, animal-, and/or metal-fibers. The fibers may advantageously be present in the form of woven or non-woven mats, or comprise strings or fibers chopped to shortened length. The fibers may advantageously be present as one or multiple layers bonded together by a thermoset matrix which may be the thermoset epoxy matrix or a thermoset matrix of a non-epoxy type. In an embodiment, the fibers may be coated e.g. with a primer. Such primers are generally known as sizing agents.

In an embodiment, the fibers comprises glass fibers, such as E-glass fibers which is alumino-borosilicate glass with low amount of alkali oxides. The glass fibers may conveniently be coated e.g. with a resin coating and/or a silane coupling agents for increasing the interfacial strength between the glass fibers and the thermoset epoxy matrix. An example of a silane coupling agent includes an epoxy functionalized organosilane or 3-glycidyloxypropyl trimethoxysilane (GPTMS).

The fibers may advantageously be present in the form of woven or non-woven mats and/or in the form of bundles.

In an embodiment, the reinforcement elements of the composite material comprises metal, such as steel, aluminum, titanium, scandium, chromium, cobalt, nickel, copper, zinc, tin, lead and any alloys comprising at least one of the before mentioned, preferably the metal is in the form of wire(s) and/or grids of metal. In an embodiment, the reinforcement comprises metal fibers and/or one or more metal girders. Metal girders may especially be suitable for the beam structure.

In an embodiment, the composite comprises non-reinforcement polymer materials, e.g. in the form of flakes or fibers, such as a non-reinforcement polymer like polypropylene (PP), polyethylene (PE), polyethylene terephthalate (PET), polyamide (PA), polymethylpentene (PMP) or any mixture comprising at least one of these.

Advantageously, at least each of the compliant blade sections of the paddle blades and preferably each of the paddles comprises or consists of a composite material comprising a thermoset polymer material with embedded fibers and/or embedded non-reinforcement polymer.

The paddle blades may have any shape suitable for forming the one or more common sail arrangements. The paddle blade of the paddles of the at least one common sail arrangement are advantageously shaped such that the respective paddle blades do not mutually block the elastically deflectability of the compliant blade sections of the respective paddle blades.

The paddle blades may in principle have any shape, preferably such that they do not block for each other's elastically deflection and, preferably such that the distance of the paddle blades of a common sail arrangement it kept at a desired low level when the paddle blades are in unloaded condition.

In an embodiment, the respective paddle blades has straight edges optionally with rounded corners, such as with rounding radius of 5 cm or less, such as 2 cm or less.

Advantageously, the respective paddle blades has a blade width and a blade length ensuring a desired area or the first respectively the second opposite blade surfaces. The area of each of the first and the second opposite blade surfaces is advantageously at least 0.05 m², such as at least 0.1 m², such as from 0.2 m² to 10 m², such as from 0.3 m² to 5 m².

Where the effector is adapted for use in a wave power system to be used where relatively high energy wave are expected, it may be convenient that the paddle blade of the effector are selected to have relatively small surface area of the respective first and the second opposite blade surfaces while simultaneous the number of paddle blades is relatively high, such that the sum of first and second opposite blade surfaces of all the paddle blades is desirable high for harvesting a desired high amount of water wave energy.

Where the effector is adapted for use in a wave power system to be used where relatively low energy wave are expected, it may be convenient that the paddle blade of the effector are selected to have relatively high surface area of the respective first and the second opposite blade surfaces while simultaneous the number of paddle blades may be relatively low.

In an embodiment, the respective paddle blades has a blade width of at least 0.5 m, such as from 1 to 5 m, such as from 1.5 to 3 m.

In an embodiment, the respective paddle blades has a blade length of at least 0.1 m, such as from 0.3 m to 5 m, such as from 0.4 m to 3 m, such as from 0.5 to 2 m.

In an embodiment, at least one, preferably each of one or more of the paddle blades has a first side and a second opposite side defined by the first and second opposite blade surfaces and wherein a first support flap is located on the first side of the paddle blade. The first support flap is advantageously connected to the paddle shaft optionally via the paddle blade. The first support flap protrudes from the paddle shaft to a distance from the remote edge of the paddle blade. Preferably the first support flap has a width referred to as “flap width” and preferably determined parallel to the blade width, which flap width is up to 75% of the blade width, such as from 10% to 60% of the blade length, such as from 20% to 50% of the blade width.

Advantageously, the paddle also comprises a second support flap, which is located on the second side of the paddle blade. The second support flap may be connected to the paddle shaft optionally via the paddle blade. The second support flap protrudes from the paddle shaft to a distance from the remote edge of the paddle blade. Preferably the second support flap has a width, referred to as “flap width”, which flap width is up to 75% of blade width, such as from 10% to 60% of the blade width, such as from 20% to 50% of the blade width.

The flap widths of the first flap and the second flap may be equal or may differ from each other.

Where it is anticipated that the waves acting on the first side and the second side respectively of the paddle blade may differ in force, it may be desired to have different sizes (e.g. different flap widths) of the first and the second support flap respectively.

To obtaining a very balanced paddle it is desired that the flap widths of the first flap and the second flap are equal.

The support flap(s) has/have the function of supporting and protecting the paddle blade against damage as it will be explained further below

Advantageously, the first support flap and/or the second support flap has/have an equal or a higher stiffness than the compliant blade section of the paddle blade. Preferably the first support flap and/or the second support flap is/are of a material having an equal or a higher stiffness than the material of the compliant blade section of the paddle blade and/or wherein the first support flap and/or the second support flap has/have a thickness or an average thickness, which is equal to or larger than a thickness or an average thickness of the compliant blade section of the paddle blade. Thereby the first and the second support flaps may provide a very effective protection of the paddle blade against damage by the water waves.

The first support flap may be fixed to the first side of the paddle blade in a fixation width extending from the paddle shaft and up to 50%, such as up to 25% of the flap width of the first support flap, such as up to 10% of the flap width of the first support flap, such as up to 5% of the flap width of the first support flap. Preferably the fixation is extending in at least 50% of a length determined perpendicular to the flap width of the first support flap of the first support flap, such as in the entire length of the first support flap.

In the same way the second support flap may be fixed to the second side of the paddle blade in a fixation width extending from the paddle shaft and up to 50%, such as up to 25% of the flap width of the second support flap, such as up to 10% of the flap width of the second support flap, such as up to 10% of the flap width of the second support flap. Preferably the fixation is extending in at least 50% of a length of the second support flap, such as in the entire length of the second support flap.

By having first and second support flaps arranged at respective first and second opposite sides of the blade, without fully cover the compliant blade section of the paddle blade (i.e. by hawing a flap width that is less than the blade width) a desired high protection of the paddle blade may be provided while simultaneously ensuring a desired high deflection of the paddle blade when subjected to high forces provided by the added mass.

To ensure a very effective energy harvesting, the first blade surfaces of the respective paddle blades of the paddles forming part of the at least one common sail arrangement are preferably oriented in a common first facing direction and the second blade surfaces of the respective paddle blades of the paddles forming part of the at least one common sail arrangement are oriented in a common second facing direction opposite to the common first facing direction when the paddles are un unloaded condition. Preferably the plurality of paddles forming part of the at least one common sail arrangement are arranged with their paddle blades located in a common plane when the paddles are in unloaded condition.

The invention also comprises a wave power system comprising at least one effector as described above. The wave power system of the invention for extracting energy from water waves comprises
a basic structure comprising at least one elongate track section,
at least one effector movably engaged with the basic structurer and adapted for being moved by water waves along the elongate track section in a travelling length between a first and a second stop locations, and
an energy harvesting arrangement arranged for harvesting energy from the relative movements between the effector and the basic structurer,
   wherein the at least one effector is as described above and as claimed in the appending claims.

The at least one elongate track section has the purpose of controlling the motion of the effector provided by the water waves when in use. The effector is associated to the elongate track section to being moved back and forth along the elongate track section. The effector may be movable connected to the elongate track section by any suitable arrangements, such as a roller arrangement similar to roller coaster wheel arrangements. In an embodiment, the effector is associated to the elongate track section via a transmission arrangement, such as a transmission arrangement comprising a wagon.

Preferably the elongate track section is essentially uncurved. However, in an embodiment, the elongate track section may be slightly curved, such as with a curving radius of 25 meters or more, such as a minimum curving radius of 50 meters or more, such as a minimum curving radius of 100 meters or more.

In an embodiment, the elongate track section is straight or substantially straight.

Preferably, each of the respective paddle blades of the paddles forming part of the at least one common sail arrangement of the effector, independent from each other or in unison are oriented perpendicular to the at least one elongate track section or are oriented substantially perpendicular to the elongate track section. The angle between the orientation of the paddle blades and the elongate track section are determined at a location of the elongate track section where the common sail arrangement are located. In an embodiment the respective paddle blades of the paddles forming part of the at least one common sail arrangement of the effector, independent from each other or in unison are oriented in an angle of up to 30° from perpendicular, such as up to 20°, such as up to 10°, such as up to 5° from perpendicular to the at least one elongate track section when the paddles are in unloaded condition.

The travelling length conveniently has a length of at least 1 m, such as at least 2 m, such as up to 10 m or even more. The desired travelling length depends largely on the expected wavelengths of the water waves where the wave power system is designed for operating.

Where the effector is engaged with the basic structure via a transmission arrangement, such as a wagon movable along the basic structure and carrying the effector, the travelling length+a length of the wagon determined along the elongate track section is conveniently at least 1.1 m, such as at least 2.1 m, such as up to 15 m or more.

The at least one effector of the wave power system is advantageously adapted for operating in at least two operation modes. Thus, in an embodiment, the at least one effector in use when submerged in sea water is adapted for being operating in at least two operation modes comprising an unleashed mode and a suppressed mode when moved by water waves along the elongate track section in a travelling length between the first and the second stop locations.

The suppressed mode is where the travelling of the effector is suppressed, i.e. where the wave power in a given direction does not take full effect. I.e. the kinetic energy of the effector (or wagon with the effector) is suppressed relative to what it would have been without the suppression of the effector.

When there is no substantially suppression of the motions due to the wave power (i.e. other than ordinary unavoidable mechanical resistance between the elongate track section and the effector), the effector is in unleashed mode.

The at least one effector is conveniently in the suppressed mode when in motion from a first brake location towards the first end location and when in motion from a second brake location towards the second end location.

The at least one effector is conveniently in the unleashed mode when in motion from the second end location and until it reaches the first brake location and again from the first end location and until it reaches the second brake location.

In an embodiment, the at least one effector is in the unleashed mode when being moved from the second stop location towards the first stop location until the effector reaches the first brake location, the at least one effector is in the suppressed mode from passing the first brake location to reaching the first stop location, the at least one effector is in the unleashed mode when being moved from the first stop location towards the second stop location until the effector reaches the second brake location, the at least one effector is in the suppressed mode from passing the second brake location to reaching the second stop location.

The distance between the first brake location and the first end stop and the distance between the second brake location and the second end stop, independently of each other is zero or up to 25% of the travelling length between the first and the second stop locations, such a up to 20%, such as up to 10%, such as up to 5 m, such as up to 0.5 m, such as up to 0.2 m of the travelling length between the first and the second stop locations.

Where the distance between the first brake location and the first end stop respectively the distance between the second brake location and the second end stop is zero, the effector is subjected to immediate stop at respectively the first and the second end stop. This immediate stop may e.g. be provided by the effector or the wagon carrying the effector colliding with at stop element at respectively the first and the second end stop. Due to the compliance of the paddle blade the risk of damage of the effector due the force provided by added mass of the water following the paddle blade and acting on the rear side of the paddle blade relative to the motion direction immediately prior to the immediate stop may be highly reduce or even fully avoided.

In an embodiment, it is desired that the distance between the first brake location and the first end stop respectively the distance between the second brake location and the second end stop larger than zero. Thereby a more abrupt stop of the effector may be obtained. In addition an amount of the suppressed energy may be collected and may be released to the effector when it has changed its travelling direction.

In an embodiment, the at least one effector in use when submerged in sea water is adapted for being moved by water waves along the elongate track section in the travelling length between the first and second stop locations in the unleashed mode respectively the suppressed mode, wherein the selected load applied to one of the faces of the compliant blade section to provide an elastically deflection of the respective compliant blade sections of the respective paddle blades is selected such that the compliant blade sections of the respective paddle blades are elastically deflected when the effector is in at least a portion of the suppressed mode.

Advantageously, the selected load applied to one of the faces of the compliant blade section to provide an elastically deflection of the respective compliant blade sections of the respective paddle blades is selected such that the compliant blade sections of the respective paddle blades are less elastically deflected when the effector is in the unleashed mode than when the effector is in at least a portion of the suppressed mode.

In an embodiment, the selected load applied to one of the faces of the compliant blade section to provide an elastically deflection of the respective compliant blade sections of the respective paddle blades is selected such that the compliant blade sections of the respective paddle blades are elastically deflected when the effector is in the unleashed mode.

The wave power system advantageously comprises a brake arrangement adapted for suppress the motion of the effector in the suppressed mode e.g. when the effector is in motion from the first brake location towards the first end stop and/or from the second brake location towards the second end stop.

The basic structure may comprise at least a part of the brake arrangement and/or the elongate track section may comprise at least a part of the brake arrangement and/or the wagon (if any) may comprise at least a part of the brake arrangement and/or the effector may comprise at least a part of the brake arrangement. Variations of this will be clear from the examples and figures.

In an embodiment, wherein the effector is engaged with the basic structure via a wagon movable along the basic structure and carrying the effector, the wagon comprises at least a part of the brake arrangement.

The brake arrangement may be any brake arrangement suitable for suppressing the motion of the effector as it passes from the first brake location towards the first end stop and/or from the second brake location towards the second end stop.

Advantageously, the brake arrangement is a regenerative brake arrangement which is adapted for converting at least a portion of the kinetic energy of the effector into a form that can be either used immediately e.g. by being released to the effector when the travelling direction has changed or the kinetic energy may be stored until needed for any other purposes.

By suppressing the effector motion (or the wagon with the effector motion) relative to the motion without the braking arrangement the kinetic energy of the effector (or wagon with the effector) is reduced and at least a portion of this kinetic energy may be converted by the brake arrangement.

In an embodiment, the brake arrangement is a mechanical operating brake arrangement, wherein the mechanical operating brake arrangement preferably is a regenerative brake arrangement, preferably configured for converting at least a part of the kinetic energy to potential energy.

Advantageously, the regenerative brake arrangement comprises a spring arrangement and/or a piston arrangement for temporarily storing the converted kinetic energy kinetic energy.

The harvesting arrangement may in principle include any type of harvesting arrangements, such as the harvesting arrangements known in the art for harvesting and converting kinetic energy to for example electricity and/or potential energy or pump energy etc.

In an embodiment, the energy harvesting arrangement comprises a pump arrangement adapted for pumping water activated by the motion of the at least one effector. The pump arrangement may for example comprise at least one hydraulic pump arrangement, such as a telescopic hydraulic rams or a piston pump comprising a piston and a pump house, wherein a first one of the piston and the pump house is held in fixed position relative to the basic structure.

The piston pump may be as described in co-pending application DK PA 2023 70508.

In an embodiment, the other one of the piston and the pump house is fixed to the wagon or the other one of the piston and the pump house is not fixed to the wagon but is located such that it will be activated by the wagon when moved along the basic structure. Thereby an effective energy conversion may be effectuated.

The wave power system may advantageously comprise a multitude of modules, wherein each module comprises
a module basic structure comprising a elongate track section, and
at least one effector movably engaged with the module basic structurer and adapted for being moved by water waves along the elongate track section in a travelling length between two stop locations,

The module basic structure of the respective modules may form part of the basic structure of the wave power system.

Thereby a very scalable wave power system may be provided. In addition it may be relatively simple to add new modules to an already established wave power system. Also, it may be relatively simple to withdraw a damage or worn module from a wave power system for replacement or repair, without the wave power system needs to be taking out of operation.

The energy harvesting arrangement may conveniently be arranged for harvesting energy from the relative movements between the effector and the module basic structurer of the respective modules.

The wave power system may in an embodiment be as described in WO2022/214153, with the difference that the effector(s) and optionally the modes of operation, i.e. the unleashed mode respectively the suppressed mode the controlling thereof is as described herein.

In an embodiment, the wave power system is as the wave power device described in US2020088155 with the modification that effector optionally the modes of operation, i.e. the unleashed mode respectively the suppressed mode the controlling thereof is as described herein.

To ensure a desired location of the wave power system relative to the water surface, the wave power system may advantageously comprise a plurality of buoyancy elements. The desired number and buoyancy effect of the buoyancy elements depends largely on the number and weight of the duct sections.

The buoyancy elements may be arranged for holding the basic structure at a desired buoyancy state relative to water surface for optimal harvesting of energy from the water waves.

Advantageously, the buoyancy elements are arranged for making the structure partly for fully buoyant.

Due to the almost neutral buoyancy of the basic structure, it will be relatively easy to couple to the effectors that have a slight buoyancy and thus keeps the whole system near the water surface, preferably such that the effectors are at least 80% by area submerged determined at still water, such as at least 90% by area submerged, such as at least 95% by area submerged, such as fully submerged determined at still water.

In principle, the effectors may be arranged for being moved in any directions by the water.

Water wave's displacement and frequency are often inconsistent and unpredictable. Generally, a water particle in a rolling wave travels in a circular or elliptical pattern, which comprises a vertical component and a horizontal component.

The effector may be adapted for being moved by a horizontal component of the water waves and/or by a vertical component of the water waves (rise and fall of the water).

Advantageously, effectors are movably engaged with the basic structure by being connected to the basic structure via transmission arrangement(s), for example each effector may be connected to the basic structure via one or more, such as one or two transmission arrangements.

The transmission arrangements may for example be as described in US2020088155.

In an embodiment, the transmission arrangement comprises at least one hydraulic ram directly or indirectly connected to the basic structure and directly or indirectly connected to the at least one effector.

All features of the invention(s) and embodiments thereof including ranges and preferred ranges can be combined in various ways within the scope of the invention, unless there are specific reasons not to combine such features.

### BRIEF DESCRIPTION OF THE EXAMPLES AND DRAWING

The invention will be illustrated further below in connection with examples and embodiments and with reference to the figures. The figures are schematic and may not be drawn to scale. The examples and embodiments are merely given to illustrate the invention and should not be interpreted to limit the scope of the invention.

FIG. 1 is a schematic illustration of a wave power system according to an embodiment of the invention comprising a basic structure with a plurality of elongate track sections each with at least one effector.

FIG. 2 is a schematic illustration of a portion of a wave power system according to an embodiment of the invention.

FIG. 3 is a schematic illustration of a portion of another wave power system according to an embodiment of the invention.

FIGS. 4a-4d are schematic side views of a portion of an embodiment of a wave power system in operation through a cycle of operation.

FIGS. 5a-5c are schematic side views of a portion of an embodiment of a wave power system in operation wherein the wave power system comprises at least one regenerative brake arrangement.

FIG. 6 is a schematic top view of a portion of an elongate track section and an associated effector operating in suppressed mode.

FIG. 7a is a schematic illustration of a perspective view of an embodiment of an effector.

FIG. 7b is a paddle of the effector of FIG. 7a.

FIG. 8a is a cross sectional view of a paddle with a paddle blade in unloaded condition.

FIG. 8b is a cross sectional view of the paddle with the paddle blade of FIG. 8a with a compliant blade section thereof in elastic deflected condition.

FIG. 9a is a side view of a paddle with a first support flap and a second support flap located at respectively the first and the second opposite sides of the paddle blade pf the paddle when in unloaded condition.

FIG. 9b is a front view of the paddle of FIG. 9a.

FIG. 10a illustrates an arrangement of a paddle with a first support flap located at the first side of the paddle blade of the paddle and wherein a force is acting on the second blade surface.

FIG. 10b illustrates the arrangement of FIG. 10a, wherein a force is acting on the first blade surface.

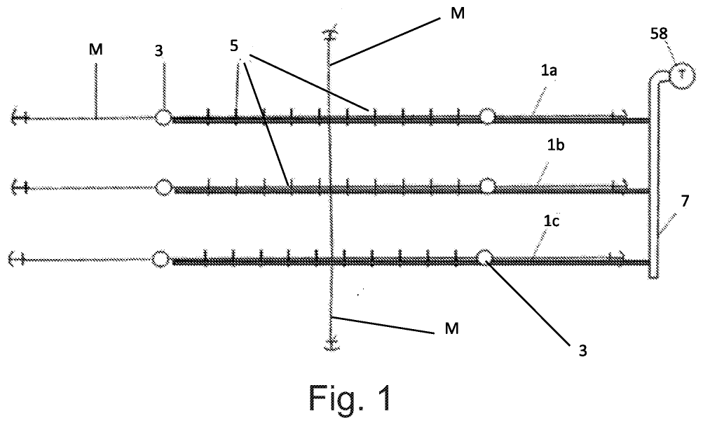

FIG. 1 show a wave power system comprising a basic structure comprising three sets of elongate track sections 1a, 1b, 1c connected to a common manifold 7 for transferring water pumped by the motions of the effectors 5 to a turbine generator 8. The common manifold 7 and the generator 8 form part of an energy harvesting arrangement arranged for harvesting energy from relative movements between the effectors 5 and the basic structurer.

Each set of elongate track sections 1a, 1b, 1c comprises a number of elongate track sections each associated with an effector 5, which is movably engaged with the respective associated track section and adapted for being moved by water waves along the associated elongate track section in respective travelling length between not shown first and second stop locations.

In the shown embodiment the respective elongate track sections are straight track sections. As explained the elongate track section may be curves as long as the effector are movable along the elongate track section between the first and the second end stops.

The elongate track sections are arranged In in lengthwise extension of each other to form the three sets of elongate track sections 1a, 1b, 1c.

The stop locations may ensure that the respective effectors are not colliding. At least one or preferably each of the stop locations may e.g. comprises a stop block or plate and/or the first and the second stop location may each comprise a hydraulic pump arrangement, such as a telescopic hydraulic cylinder or a piston pump comprising a piston and a pump house e.g. as described below. The sets of elongate track sections 1a, 1b, 1c are moored by mooring lines M. The sets of elongate track sections 1a, 1b, 1c may further comprises a number of buoyancy elements 3, where only a representative number of these are shown in addition or alternative to the buoyancy elements 3, the basic structure and/or the effectors 5 may comprise integrated light weight material, such as balsa and/or polymer foam e.g. embedded in thermoset polymer (advantageously epoxy), which thereby may have buoyancy effect.

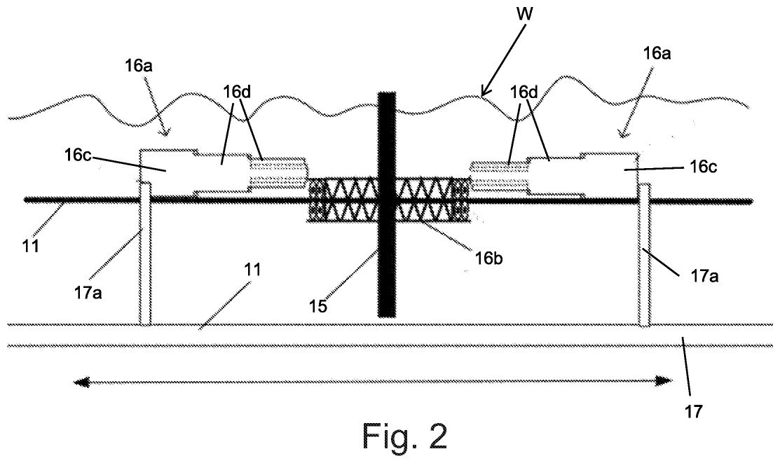

FIG. 2 illustrates a portion of a wave power system. The portion of the wave power system shown, illustrates a module of the wave power system comprising a single effector 15. The wave power system comprises a basic structure comprising an elongate track section 11 and the shown module comprises the effector 15 movably engaged with the elongate track section 11. A transmission arrangement comprising a wagon 16b and two hydraulic pump arrangements in the form of two telescopic hydraulic rams 16a are arranged to control the travelling of the effector 15 along the elongate track section 11. The effector 15 is mounted to and carried by the wagon 16b to being moved by water waves along the elongate track section 11. The wagon 16b may for example be equipped with wheels e.g. as described above for ensuring low frictional resistance between the wagon 16b and the elongate track section 11. Each end of the wagon 16b is mounted to a respective of the two telescopic hydraulic rams 16a.

The telescopic hydraulic rams 16a are adapted for pumping water into respective pipe sections 17a and further in to a pipeline 17 for transferring the pumped water to a turbine generator.

Each of the telescopic hydraulic rams 16a comprises a number of telescopic hydraulic sections comprising a main hydraulic section 16c, which are mounted to the pipe section 17a, and a number of displaceable hydraulic sections 16d, which are displaceable into the main hydraulic sections 16c for pumping water into the pipeline 17 via the pipe sections 17a. The wagon 16b is fixed to an outermost of the hydraulic sections 16d of each of the hydraulic rams 16a to thereby stabilize the movements of the effector 15 as it moves forth and back. The stabilizer 16b is moves together with the effector 15, and transfer the pumping effect to the hydraulic rams 16a, which thereby pumps water into the pipeline 17 via the pipe sections 17a. The waterline is illustrated with “W”.

The effector 15 comprises a beam structure and a plurality of not shown paddles as described elsewhere herein.

The first end stop location is defined by the location of the effector 15 when the wagon 16b has been moved along the elongate track section 11 to fully compress a first of the hydraulic rams 16a, i.e. when the displaceable hydraulic sections 16d have been displaceable into the main hydraulic sections 16c.

The second end stop location is defined by the location of the effector 15 when the wagon 16b has been moved along the elongate track section 11 to fully compress a second of the telescopic hydraulic rams 16a, i.e. when the displaceable hydraulic sections 16d have been displaceable into the main hydraulic sections 16c.

The traveling length is defined by the first and second stop locations.

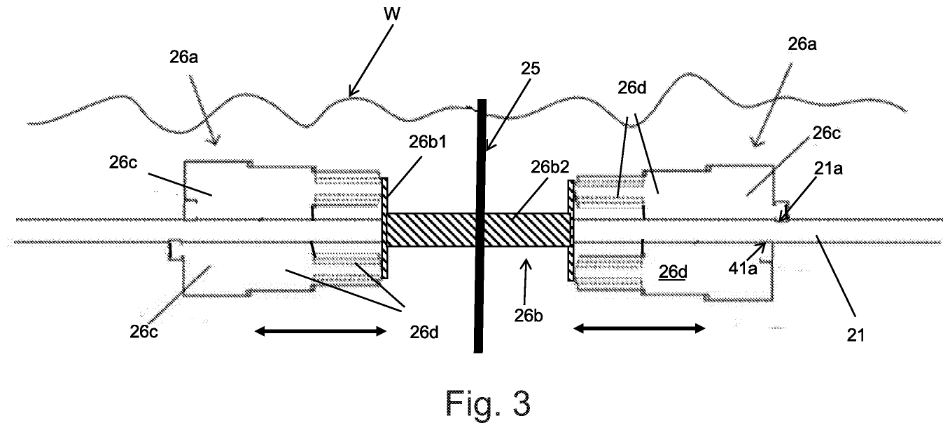

FIG. 3 illustrates a section of a wave power system comprising an elongate track section 21 is hollow and form part of a pipeline for guiding pumped water to a turbine generator. The elongate track section 21 has a number of inlet openings 21a and a pump arrangement comprising four telescopic hydraulic rams 26a and transmission arrangement comprising a wagon 26b is connected to the elongate track section 21 for feeding water directly into the elongate track section 21, which thereby also serves as a part of the pipeline for transferring the pumped water to the turbine generator.

Each of the telescopic hydraulic rams 26a comprises a number of telescopic hydraulic sections comprising a main hydraulic section 26c, and a number of displaceable hydraulic sections 26d, which are displaceable into the main hydraulic sections 26c for pumping water into the elongate track section 21. The wagon 26b is fixed to an outermost of the hydraulic sections 26d of each of the telescopic hydraulic rams 26a stabilize the movements of the effector 25 as it is moved forth and back by water waves. The wagon 26b comprises a flange 26b1 for connection to the telescopic hydraulic rams 26a and a body portion 26b2, with a bearing between the elongate track section and the body portion 26b2 which allows the wagon 26b to move together with the effector 25, and transfer the pumping effect to the telescopic hydraulic rams 26a, which thereby pumps water into the elongate track section 21. The bearing may e.g. be a ball bearing or a roller bearing. The waterline is illustrated with “W”.

A first end stop location is defined by the location of the effector 25 when the wagon 26b has been moved along the elongate track section 21 to fully compress a first pair of the telescopic hydraulic rams 26a, i.e. when the displaceable hydraulic sections 26d have been displaceable into the main hydraulic sections 26c.

A second end stop location is defined by the location of the effector 25 when the wagon 26b has been moved along the elongate track section 21 to fully compress a second pair of the telescopic hydraulic rams 26a, i.e. when the displaceable hydraulic sections 26d have been displaceable into the main hydraulic sections 26c.

The traveling length is defined by the first and second stop locations.

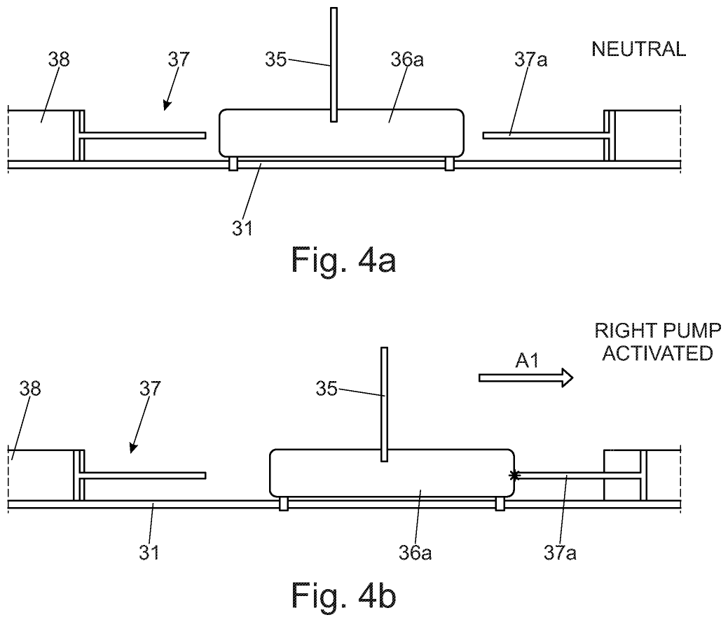

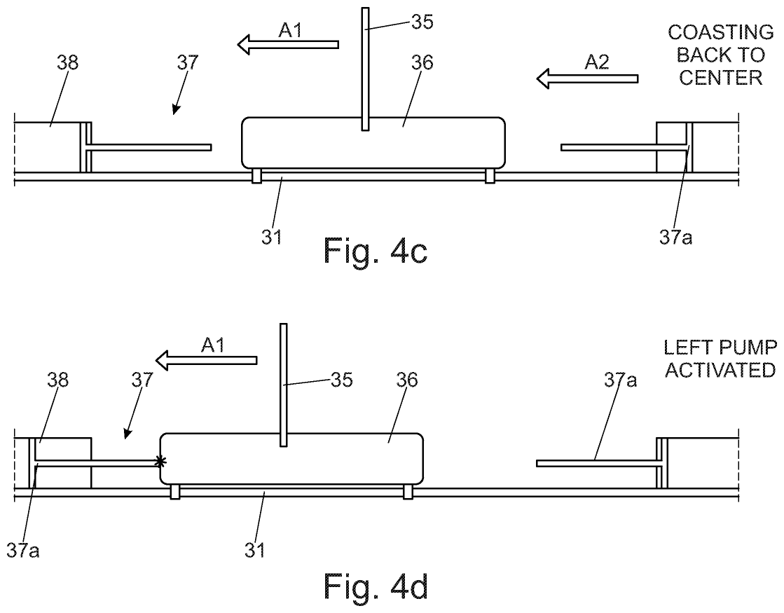

FIG. 4a-4c illustrates a section of a wave power system comprising an elongate track section 31, an effector 35 and a transmission arrangement comprising a wagon 36. The effector 35 is carried by the wagon 36 and ii engaged with the elongate track section 31 via the wagon 36, which in the shown embodiment comprises wheels for reducing friction between the elongate track section 31 and the wagon 36. The wave power system further comprises a first and a second pump arrangements each in the form of a piston pump comprising a piston 37 and a pump house 38.

The piston has a not shown piston head located in the hosing 38 and a piston rod 37a fixed to the piston head and extending more or less outside the hosing depending on the stage of the operation cycle of the pump arrangement. The piston rod 37a extends out from the housing 38 towards or in contact with one of the sides (e.g. front-bag sides) of the wagon 36.

The housing 38 is held in fixed position relative to the elongate track section 31, e.g. by being fixed to the elongate track section 31.

In FIG. 4a the wagon 36 is at stand still between the first and the second pump arrangements which will also be referred to as the left and the right pump arrangements in the description of the FIGS. 4a-4d. The wagon 36 is not in contact with any of the piston rods 37a of the left and the right pump arrangements.

In FIG. 4b, the wagon has been moved by the water waves into contact with the piston rod 37a of the right pump arrangement and due to the kinetic energy of the wagon 36 and effector 35 provided by being moved by the water waves the piston rod 37a presses the piston head further into the housing 38 and thereby pump water, which may be guided via a pipe to a generator or similar energy harvesting equipment of the energy harvesting arrangement. The arrow A1 illustrates the motion direction of the wagon 36 and effector 35.

As the wagon starts to compress the piston rod 37a of the right pump arrangement the effector switches from operating in unleashed mode to operate in suppressed mode until the wagon 36 and effector 35 reached the right end stop and are at full stop relative to the elongate track section 31.

In FIG. 4c the water waves has started to move the wagon 36 with the effector 31 away from the right pump arrangement. The effector thereby switches from operation in suppressed mode to operate in unleashed motion as the waver waves presses the wagon towards the left pump arrangement. The piston pump of the right pump arrangement comprises a piston retraction arrangement adapted for refilling the housing with water and retracting the piston rod towards its initial position before being compressed by the wagon 36. As seen in FIG. 4 c the piston rod has stated retracting. The piston of the left pump arrangement has a similar retracting arrangement.

In FIG. 4d, the wagon has been moved by the water waves into contact with the piston rod 37a of the left pump arrangement and due to the kinetic energy of the wagon 36 and effector 35 provided by being moved by the water waves the piston rod 37a presses the piston head further into the housing 38 and thereby pump water, which may be guided via a pipe to a generator or similar energy harvesting equipment of the energy harvesting arrangement. The arrow A1 illustrates the motion direction of the wagon 36 and effector 35.

As the wagon starts to compress the piston rod 37a of the left pump arrangement the effector switches from operating in unleashed mode to operate in suppressed mode until the wagon 36 and effector 35 reached the left end stop and are at full stop relative to the elongate track section 31. At the same time it can be seen that the piston rod of the right pump arrangement is now fully retracted and ready for next circle of operation.

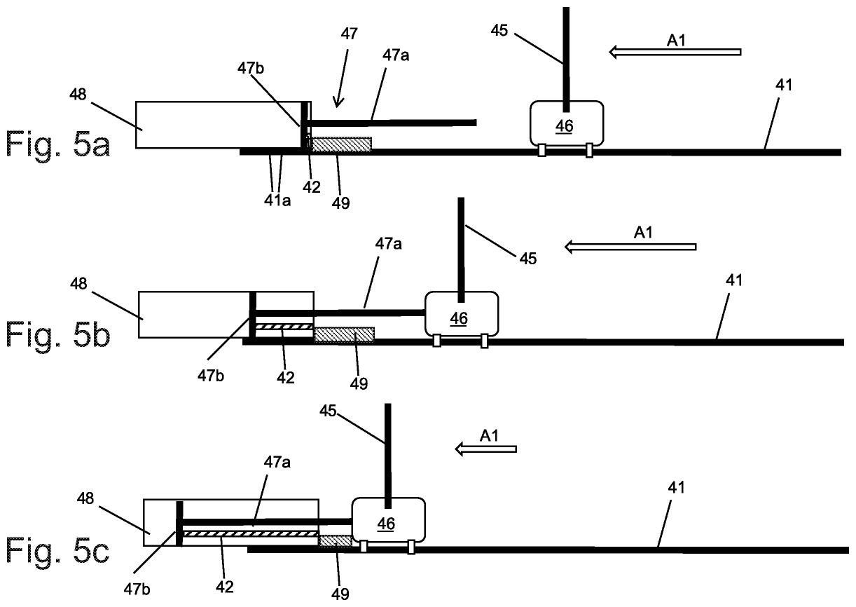

FIGS. 5a-5c illustrates a section of a wave power system wherein the wave power system comprises at least one regenerative brake arrangement.

The wave power system comprises an elongate track section 41, an effector 45 and a transmission arrangement comprising a wagon 46. The effector 45 is carried by the wagon 46 and ii engaged with the elongate track section 41 via the wagon 46, which in the shown embodiment are engaged with the elongate track section 41 via mounting rings 46a, preferably comprising a not shown roller bearing for reducing friction between the elongate track section 41 and the wagon 46. The wave power system further comprises a pump arrangements in the form of a piston pump comprising a piston 47 and a pump house 48. In the shown embodiment the pump arrangement is located left relative to the wagon 46, it should be understood that the wave power system conveniently comprises a corresponding pump arrangement located right to the wagon 46.

The piston has a piston head 47b located in the hosing 48 and a piston and a piston rod 47a fixed to the piston head and extending more or less outside the hosing depending on the stage of the operation cycle of the pump arrangement. The piston rod 47a extends out from the housing 48 towards or in contact with one of the sides of the wagon 46. The housing 48 is held in fixed position relative to the elongate track section 41 by being fixed to the elongate track section 41 in fixing location 41a.

The pump arrangement comprises a regenerative brake arrangement comprising a spring arrangement 49. The piston pump comprises a piston retracting arrangement, with a cord 42 adapted for retracting the piston rod 47a after it has been released from being compressed further into the housing 48 by the wagon 46 as described below.

In FIG. 5a, the water waves has started to move the wagon 46 with the effector 41 towards the pump arrangement. The effector 45 is operating in unleashed motion as the waver waves presses the wagon towards the pump arrangement. The arrow A1 illustrates the motion direction of the wagon 46 with the effector 45.

In FIG. 5a, the wagon 46 has been moved by the water waves into contact with the piston rod 47a and due to the kinetic energy of the wagon 46 and effector 45 provided by being moved by the water waves, the piston rod 47a presses the piston head 47b further into the housing 48 and thereby pump water, which may be guided via a pipe to a generator or similar energy harvesting equipment of the energy harvesting arrangement. The arrow A1 illustrates the motion direction of the wagon 46 with the effector 45.

As the wagon 46 starts to compress the piston rod 47a, the effector 45 switches from operating in unleashed mode to operate in suppressed mode.

As the wagon 46 presses the piston head 47b further into the housing 48, the piston pump simultaneously brakes the wagon 46. At the same time as the piston head 47b is pressed further into the housing 48, the retracting arrangement is activated, here comprising an elastic cord 42 that is stretched.

In FIG. 5c, the wagon 46 with the effector 45 has started to activate the spring arrangement 49, which also acts to brake the wagon 46 and which provides a regenerative brake function.

At a certain point in time, the wagon 46 with the effector 45 will reach the left end stop and will be at full stop relative to the elongate track section 41. The spring arrangement 49 will then be highly compressed and the elastic cord 42 will be stretched to a point of balance where the wagon 46 do no longer press towards the piston rod 47a. Unless the wagon is locked in this position, the motion direction will at this point in time change and the effector 45 will switch from operation in suppressed mode to operate in unleashed mode. The spring arrangement 49 will push the wagon away from the pump arrangement and the water waves will move the wagon 46 with the effector 45 further, preferably towards a pump arrangement arranged on the right to the wagon 46 with the effector 45.

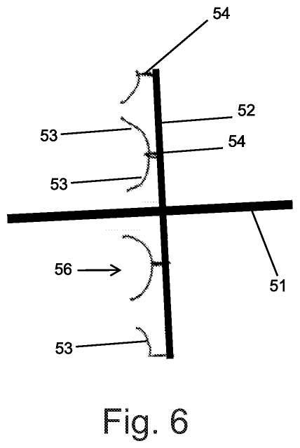

FIG. 6 shows a portion of an elongate track section 51 and an associated effector operating in suppressed mode. The effector comprises a plurality of paddles 56, each comprising a paddle shaft 54 and at least two paddle blade 53. The paddles are rigidly connected to a beam 52 of a beam structure of the effector. In the shown embodiment, the effector is operating in suppressed mode in motion in the direction shown with the arrow A1. Due to the suppression of the motion the water immediately around the respective paddle blade 53 are moving faster than the effector and apply an added mass effect to the paddle blades 53 as described above and due to the compliant blade section of the respective paddle blades 53, which in this example is provided by the entire paddle blades, the paddle blades 53 are deflecting in the same direction as the motion of the effector, whereby the gap between adjacent paddle blades 53 increases allowing a part of the water with higher velocity than the effector to pass the paddle blades without damaging the effector.

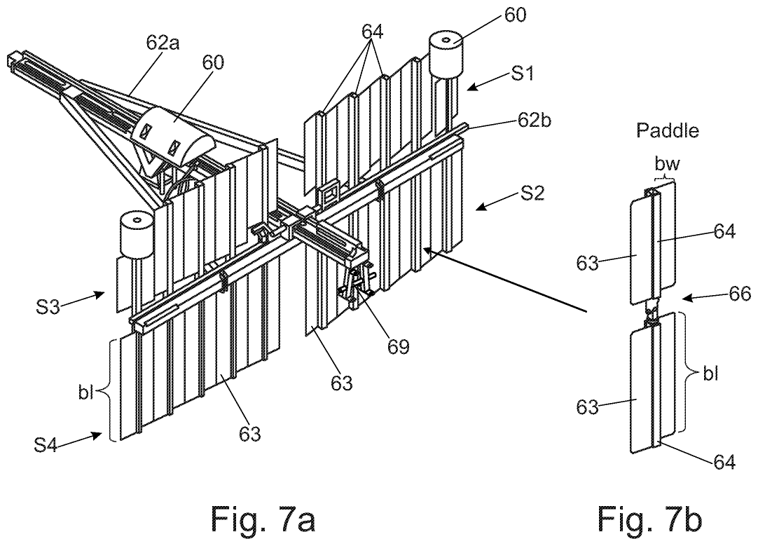

The effector shown in FIG. 7a comprises a beam structure 62a, 62b and a plurality of paddles 66, each paddle 66 comprises a paddle shaft 64 and 4 paddle blades 63 with a first and a second opposite blade surfaces, a blade length bl along the paddle shaft 64 and a blade width bw perpendicular to the blade length, wherein the plurality of paddles 66 are fixed to a beam 62b of said beam structure 62a, 62b, to provide that the paddle blades are located to form part of 4 common sail arrangement S1, S2, S3, S4, when said paddles 66 are in unloaded condition. As described elsewhere herein each of the paddle blades 63, at least in a compliant blade section thereof is elastically deflectable upon a selected load applied to one of a first and a second opposite compliant blade section surfaces of the compliant blade section of the paddle blade.

The respective paddles 66 are fixed to the beam 62 so that the respective 4 paddle blades 63 of each paddle 66 are located such that two opposite paddle blades 63 are located at a first end of the paddle shaft 64 and the two other of the paddle blades 6 are located at a second opposite end of the paddle shaft 64. Thereby the paddle blades 63 two and two form part of distinct common sail arrangements S1, S2, S3, S4. A number of the paddles 66 are located on one side of a center beam of the beam structure 62a, 62b and a number of the paddles 66 are located on the other side of the center beam of the beam structure 62a, 62b. The center beam carries a regenerative brake arrangement comprising a spring arrangement 69. A number of buoyancy modules 60 are mounted to the effector.

In FIG. 7b one of the paddles 66 of the effector is show.

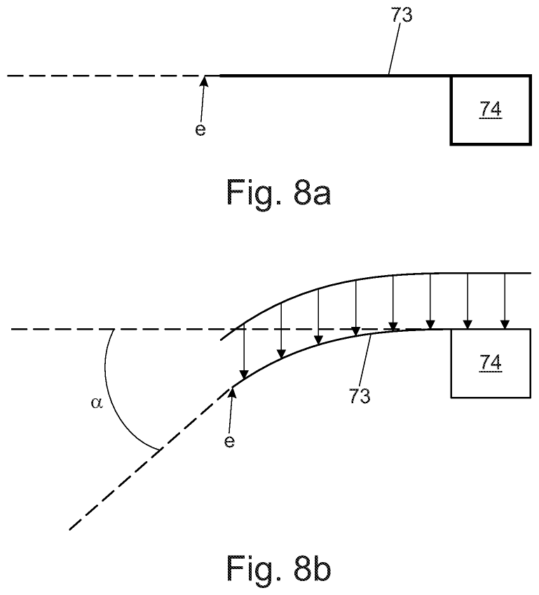

FIG. 8a illustrates a paddle with a paddle blade in unloaded condition. The paddle comprises a paddle shaft 74 and a paddle blade 73 with a compliant blade section fixed to the paddle shaft 74.

In FIG. 8b the paddle blade 73 is subjected to a load in the form of a force applied to one of a first and a second opposite compliant blade section surfaces as illustrated with the arrows. It can be seen that the edge e of the paddle blade furthest from the paddle shaft 74 is angular displaced with the angle a. As it can be seen the compliance of the paddle blade 73 is increasing from the paddle shaft 74 to the edge e of the paddle blade furthest from the paddle shaft.

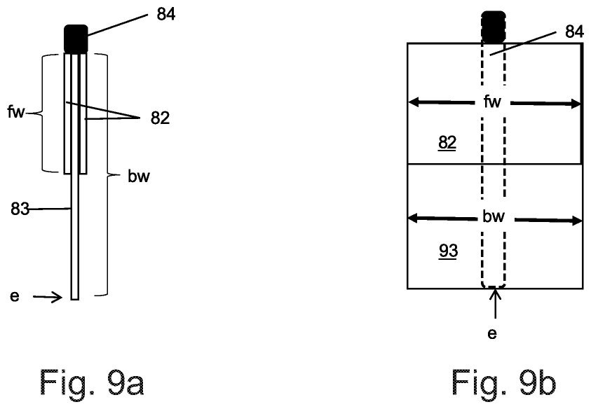

The paddle shown in FIGS. 9a and 9b comprises a paddle shaft 84 and a paddle blade 83 where a first and a second support flaps 82 located at respectively the first and the second opposite sides of the paddle blade 83. The support flaps 82 are not fixed to the paddle blade 83 but may in a variation thereof be fixed to the paddle blade 83 in a relatively short width extension (e.g. as described above) of the paddle blade 83 closest to the paddle shaft 84.

that when the paddle blade 83 is in unloaded condition as shown in FIGS. 9a and 9b the first and second support flaps 82 are in face-to-face contact with the respective first and second opposite sides of the paddle blade 83.

The paddle blade 83 further has a remote edge 81 furthest from the paddle shaft 84 and a width bw extending from the paddle shaft 84 to the remote edge 81.

The width fw of the respective first and second support flaps 82 are equal in the shown embodiment. The skilled person would understand that the respective widths fw of the first and second support flaps 82 may in alternative embodiments differ from each other e.g. as described above. In the shown embodiment, the width fw of the respective first and second support flaps 82 are about half the length of the width bw of the paddle blade 83. As described elsewhere herein, the respective widths fw of the first and second support flaps 82 may is alternative embodiments be wider or narrower relative to the width wf of the paddle blade 83.

The paddle blade 83 has a length bl and the first and second support flaps 82 respectively has a length fl. In the shown embodiment, the lengths fl of the respective first and second support flaps 82 are equal to the length bl of the paddle blade 83. As described elsewhere herein the respective lengths fl of the first and second support flaps 82 may is alternative embodiments be larger or smaller than relative to the length bl of the paddle blade 83.

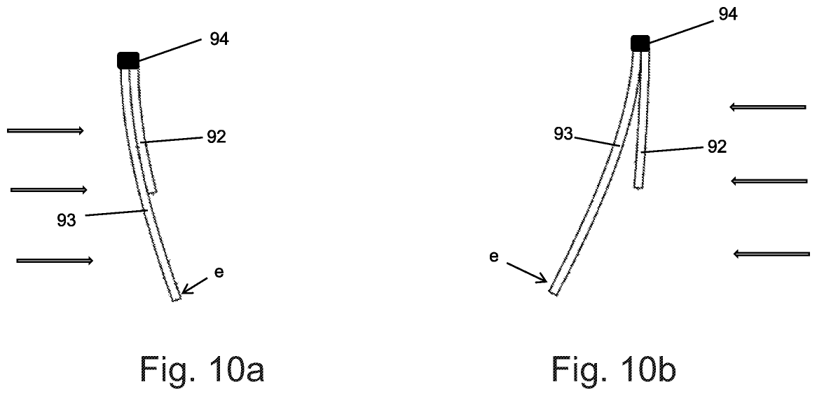

The paddle shown in FIG. 10a comprises a paddle shaft 94, and a paddle blade 93 where a first support flap 92 located at the first side of the paddle blade of the paddle and wherein a force as illustrated by the arrows, applies a load acting on the second blade surface of the paddle blade 93. As it can be seen the paddle blade 93 is pressed towards the first support flap 92, which thereby supports the portion of the paddle blade 93 closest to the paddle shaft 94, while simultaneously do not prevent the portion of the paddle blade further from the paddle shaft 94 to deflect due to the applied load. Advantageously, at least the portion of the paddle blade 93 extending beyond the support flap 92 for part of the compliant blade section of the paddle blade 93, which thereby is elastically deflectable upon the applied load.

In FIG. 10b, a force as illustrated by the arrows, applies a load acting on the first blade surface of the paddle blade 93 and also partly on the supporting flap 92, which advantageously has a higher stiffness than the paddle blade 93.

As it can be seen the paddle blade 93 or at least the compliant blade section thereof is elastically deflected substantially unaffected by the first support flap 92.

Thereby the one or more support flaps may act to support and protect the paddle blade without any substantially suppressing of the deflectability of the compliant blade section. Thus, for example by having first and second support flaps arranged at respective first and second opposite sides of the paddle blade 9a and 9b, a desired high support and protection of the paddle blade may be provided while simultaneously ensuring a desired high compliance of the paddle blade.

1-38. (canceled)

39. An effector for a wave power system, the effector comprises a beam structure and a plurality of paddles, each paddle comprises a paddle shaft and at least one paddle blade with a first and a second opposite blade surfaces, a blade length along the paddle shaft and a blade width perpendicular to the blade length, wherein the plurality of paddles are fixed to said beam structure, to provide that the paddle blades are located to form part of at least one common sail arrangement when said paddles are in unloaded condition, and wherein each of said paddle blades, at least in a compliant blade section thereof is elastically deflectable upon a selected load applied to one of a first and a second opposite compliant blade section surfaces of the compliant blade section of the paddle blade.

40. The effector of claim 39, wherein the compliant blade section comprises 10% or more of the blade width from paddle shaft to a furthest edge.

41. The effector of claim 39, wherein the compliant blade section has a compliance sufficiently high to provide that when a force to one of the first and the second compliant blade section surfaces of each of the respective paddle blades, an edge of the paddle blade furthest from the paddle shaft will be angular displaced with at least 15° relative to the edge in unloaded condition without resulting in irreversible plastic deformation, wherein the force is applied by water pressure by submerging the paddle blade fully in still standard seawater at 20 °C and moving the paddle blade horizontally in a first direction normal to the first surface of the paddle blade followed by a deceleration of 5 m/s².

42. The effector of claim 39, wherein the paddle blades of a common sail arrangement are located in a side-by-side configuration, wherein two or more of the paddle blades overlap with each other.

43. The effector of claim 39, wherein the paddle shaft has a higher flexural stiffness than a flexural stiffness of said compliant blade section of the at least one paddle blade of the respective paddles.

44. The effector of claim 39, wherein the paddle shafts of the paddles comprising the paddle blades of the at least one common sail arrangement are connected to at least one beam of the beam structure in rotational restricted joints.

45. The effector of claim 39, wherein at least the compliant blade section of the paddle blades comprises or consists of a composite material comprising a polymer material with embedded fibers.

46. The effector of claim 39, wherein the paddle shaft(s) and/or at least one beam of the beam structure independent of each other comprises steel, aluminum, polypropylene (PP), polyethylene (PE), polyoxymethylene (POM), polyurethane (PU), polyamide (PA), polyethylene terephthalate (PET), and/or a composite material.

47. The effector of claim 39, wherein each of one or more of the paddle blades has a first side and a second opposite side defined by the first and second opposite blade surfaces and wherein a first support flap is located on the first side of the paddle blade, said first support flap is connected to said paddle shaft optionally via the paddle blade, said first support flap protrudes from said paddle shaft to a distance from said remote edge of said paddle blade, and a second support flap is located on the second side of the paddle blade, said second support flap is connected to said paddle shaft optionally via the paddle blade, said second support flap protrudes from said paddle shaft to a distance from said remote edge of said paddle blade.

48. The effector of claim 39, wherein the first blade surfaces of the respective paddle blades of the paddles forming part of the at least one common sail arrangement are oriented in a common first facing direction and the second blade surfaces of the respective paddle blades of the paddles forming part of the at least one common sail arrangement are oriented in a common second facing direction opposite to the common first facing direction when the paddles are in unloaded condition.

49. A wave power system for extracting energy from water waves, the wave power system comprising:
a basic structure comprising at least one elongate track section,
at least one effector movably engaged with said basic structurer and adapted for being moved by water waves along said elongate track section in a travelling length between a first and a second stop locations, and
an energy harvesting arrangement arranged for harvesting energy from said relative movements between said effector and said basic structurer,
wherein said at least one effector is according to claim 39.

50. The wave power system of claim 49, wherein each of the respective paddle blades of the paddles forming part of the at least one common sail arrangement independent from each other or in unison are oriented perpendicular to the at least one elongate track section when the paddles are in unloaded condition.

51. The wave power system of claim 49, wherein the at least one effector in use when submerged in sea water is adapted for being operating in at least two operation modes comprising an unleashed mode and a suppressed mode when moved by water waves along said elongate track section in a travelling length between said first and said second stop locations, wherein the at least one effector is in the suppressed mode when in motion from a first brake location towards a first end location and when in motion from a second brake location towards a second end location.

52. The wave power system of claim 51, wherein the at least one effector in use when submerged in sea water is adapted for being moved by water waves along said elongate track section in said travelling length between said first and second stop locations in said unleashed mode and said suppressed mode, wherein the selected load applied to one of the faces of the compliant blade section to provide an elastically deflection of the respective compliant blade sections of the respective paddle blades is selected such that the compliant blade sections of the respective paddle blades are elastically deflected when the effector is in at least a portion of the suppressed mode.

53. The wave power system of claim 51, wherein the wave power system comprises a brake arrangement adapted for suppressing the motion of the effector in the suppressed mode.

54. The wave power system of claim 53, wherein said basic structure comprises at least a part of the brake arrangement.

55. The wave power system of claim 49, wherein the effector is engaged with the basic structure via a transmission arrangement movable along the basic structure and carrying the effector.

56. The wave power system of claim 53, wherein the brake arrangement is a mechanical operating and regenerative brake arrangement comprising a spring arrangement and/or a piston arrangement for temporarily storing kinetic energy.

57. The wave power system of claim 49, wherein the energy harvesting arrangement comprises a pump arrangement adapted for pumping water activated by the motion of the at least one effector.

58. The wave power system of claim 49, wherein the wave power system comprises a multitude of modules, each module comprises
a module basic structure comprising a elongate track section, and
at least one effector movably engaged with said module basic structurer and adapted for being moved by water waves along said elongate track section in a travelling length between two stop locations,
wherein the module basic structure of the respective modules form part of the basic structure of the wave power system, wherein said energy harvesting arrangement is arranged for harvesting energy from said relative movements between said effector and said module basic structurer of said respective modules.
